(19) United States
(12) Patent Application Publication
(10) Pub. No.: US 2011/0051954 A1
(43) Pub. Date: Mar. 3, 2011

(54) SIGNAL CONDITIONER WITH SUPPRESSION OF INTERFERING SIGNALS

(75) Inventors: Henrik Thomsen, Holte (DK); Claus Erdmann Furst, Roskilde (DK)

(73) Assignee: AUDIOASICS A/S, Allerod (DK)

(21) Appl. No.: 12/863,227

(22) PCT Filed: Jan. 20, 2009
(86) PCT No.: PCT/EP09/50580

§ 371 Date: Nov. 17, 2010

Related U.S. Application Data
(60) Provisional application No. 61/024,433, filed on Jan. 29, 2008.

(51) Int. Cl. H04B 15/00

(52) U.S. Cl. 381/93

(57) ABSTRACT

A semiconductor die with an integrated circuit providing a signal conditioner (106) for a capacitive transducer (105), comprising: a gain stage (101) configured to receive an analogue transducer signal; an analogue-to-digital converter (102) coupled to receive a signal outputted from the gain stage (101) and to provide a digital signal. A feedback signal is provided via a digital-to-analogue converter (104) and a digital signal processor (103) that receives the digital signal; and the gain stage (101) is configured with a first input (107) and second input (108) coupled to receive the analogue transducer signal and the feedback signal, respectively.

### FIELD OF THE INVENTION

A signal conditioner, for a transducer, embodied on a semiconductor die with an integrated circuit comprising a preamplifier, an analogue-to-digital converter and a feedback configuration is disclosed.

### BACKGROUND

A transducer acts to convert a type of energy e.g. acoustical into electrical energy—a signal is converted into an electrical signal. The electrical signal however typically needs some type of electrical signal processing to bring it into a desired form—this is also denoted signal conditioning. A signal conditioner for a transducer acts as an intermediate signal processing stage between a transducer and any subsequent stage.

Signal conditioners for transducers are often made especially for a specific type of transducer and a specific application since, often, the signal conditioner has to meet special operating conditions set by both the type of transducer and its application. The particular operating conditions can be seen as physical limitations to and demands on the market.

In the following, as an example of such particular conditions, reference will be made to transducers of the capacitive type being operable as a microphone, and further with reference to applications in the field of so-called mobile electronic devices such as cellular telephones, cameras, portable digital assistants etc.

### The Demand

For many years the demand in this field has for many years been rather simple in that the demand was for microphones with extremely low costs and for microphones suitable for production in very high volumes. The performance of such microphones was comparable from one manufacturer to another and was at a level comparable to that of conventional telephony systems. In recent years, however, the demand has changed to also be for microphones with a performance above that of telephony systems. Today there appears to be a trend in the demand heading towards so-called high-fidelity (hi-fi) quality. In line with this, since mobile devices are increasingly used everywhere in various environments, there is a demand for improved sound quality in environments that disturb the perceived sound quality. If such a demand is met, performance will be perceived as being improved in specific situations and on an overall basis. It should be noted that commonly used measures of quality are dynamic range or signal-to-noise ratio, signal-to-distortion ratio and bandwidth.

However, unfortunately, the demand for low price seems to persist. As the cost of a semiconductor die is directly related to the size of the die, it is important, for the purpose of reducing price, that the electronic circuit integrated on the die is as small or compact as possible.

Thus, since high quality microphones are sought after, more complex circuitry is inherently needed which—other things being equal—has a higher power consumption. However, since the mobile equipment is battery powered, current consumption is subject to be minimized as much as possible.

In addition to the above there is a demand for transducers with a signal conditioner providing digital output signals. Since typically a microphone is integrated in a consumer electronics device where a substantial amount of digital signal processing is performed by mainly digital, integrated circuit chips, it is in general preferred that signals from sensors (such as microphones) are provided as digital signals. This introduces new challenges in respect of signal processing in the integrated circuits embedded with the microphones—and especially in respect of distortion in the digital domain.

Moreover, there is a demand for transducers that can be manufactured with a higher yield than today's standard of approximately 80-90%, i.e. 80-90% of the total number of produced microphones satisfies specifications on their performance. Unfortunately, 10-20% of the production is discarded since for instance the sensitivity of the microphone does not satisfy the specification. A solution to obtain a reduction of the discard rate would be highly appreciated by the industry.

In view of these and other demands it is considered difficult to further improve quality without compromising the other demands. Thus, to further improve signal conditioners for transducers in this field, a better understanding of the nature of this technical field is needed.

### Sensitivity of Microphone

The microphone is based on the principle of a capacitor which is formed by a movable member that constitutes a diaphragm of the microphone and another member, e.g. a so-called back plate of the microphone. One of the members of the microphone, e.g. the diaphragm, is charged with a constant electrical charge. The charge is either provided as an electrostatic charge captured on one of the members or provided by a voltage source e.g. a charge pump or voltage step-up circuit on the semiconductor die. A sound pressure detected by the microphone will cause the membrane to move and consequently change the capacitance of the capacitor formed by the diaphragm member and the other member. When the charge on the capacitor formed by these two members is kept constant, the voltage across the two capacitor members will change with the incoming sound pressure level. As the charge on the microphone capacitor has to be kept constant to maintain proportionality between sound pressure and voltage across the capacitor members, it is important not to load the microphone capacitance with any resistive load. A resistive load will discharge the capacitor and thereby degrade or ruin the capacitor's performance as a microphone. A capacitive load will reduce a electroacoustical sensitivity of the microphone transducer. In case a microphone with a permanent electrostatic charge is used (i.e. an electret microphone) the electroacoustical sensitivity may change over time—commonly known as an ageing phenomenon.

For small sized microphones the size of the diaphragm is limited and thus so is the capacitance of the microphone. Consequently, the input capacitance of preamplifiers for small-sized microphones has to be very small in order not to load the signal from the microphone capacitance and thus lower the signal from the microphone. Additionally, since the input resistance of the preamplifier along with the microphone capacitance form a high pass filter, the input resistance of the amplifier has to be very high in order to meet typical frequency bandwidth requirements. In order to achieve audio signal bandwidths the input resistance has to be in the Giga Ohms range such as larger than 1 Giga Ohm or 10 Giga Ohm.

Therefore, in order to pick up a microphone signal from the capacitor, amplifiers configured with the primary objective of providing high input resistance are preferred to buffer the capacitor from circuits which are optimized for other objectives. The amplifier connected to pick up the microphone signal is typically denoted a preamplifier or a buffer amplifier or simply a buffer or a gain stage. The preamplifier is typically connected physically very close to the capacitor—within a distance of very few millimetres or fractions of millimetres.

### Noise

When designing a preamplifier for a microphone there is generally three sources of electronic noise. These sources are noise from a bias resistor, 1/f noise from an input transistor, and white noise from the input transistor. Typically, input transistor noise dominates. Both white noise and 1/f noise can be minimized by optimizing the length and the width of the input transistor(s) as well as optimizing the current in the device. This applies for any input stage e.g. a single transistor stage or a differential stage.

The noise from the bias resistor can also be minimized. If the bias resistor is made very large then the noise from the resistor will be low-pass filtered and the in-band noise will be very low. This has the effect though that the lower bandwidth limit of the amplifier will be very low. This can be a problem as the input of the amplifier will settle at a nominal value only after a very long period of time after power up. Additionally, signals with intensive low frequency content arising from e.g. slamming of a door or infra sound in a car can overload the amplifier. Another related problem is small leakage currents originating from mounting of the die inside a microphone module. Such currents will, due to the extreme input impedance, establish a DC offset. This will reduce the overload margin of the amplifier.

In terms of sensitivity and noise, the microphone diaphragm has a very small size and thus low sensitivity—therefore it is important to couple the largest possible fraction of the signal from the microphone to a preamplifier, while adding the smallest possible amount of noise.

### Distortion and Artefacts

Non-linear signal conditioning in general and analogue-to-digital signal processing in particular are sources of distortion of and introduction of artefacts in the signal from the transducer. Like noise, distortion and signal artefacts are extremely difficult to remove once introduced. A source of severe distortion is e.g. clipping of signal magnitudes above or below certain signal levels. Introduction of spurious tones such as those known as idle-mode tones in sigma-delta modulators in analogue-to-digital converters are examples of known artefacts.

### Acoustic Environment

As mentioned above, mobile devices are increasingly used everywhere in different environments and hence there is a demand for improved quality in situations where the environment is a source of degraded quality.

The purpose of the microphone is to respond to an acoustic signal by converting it to an electrical signal. In some applications it may be a primary objective to respond to a broad range of acoustic signals, whereas in other applications it may be a primary objective to respond to speech signals. In the latter case, the microphone is often arranged in a device such that, under normal operating conditions, it will be relatively more sensitive to speech signals—confer e.g. the location and configuration of a microphone in a conventional cellular telephone. In usual operation the microphone will thus be more sensitive to speech signals spoken close to the microphone compared to other signals originating from the surrounding environment.

The problem is, however, that other signals originating from the surrounding environment may be very loud and hence appear far stronger to the microphone than a speech signal spoken at close distance. Since the microphone is sensitive to the integrated or resulting sound pressure acting on the membrane and caused by the speech signal and other (loud) signals from the surroundings, relatively weak signals will be blended with relatively strong signals.

The microphone transducer may be operational up to extremely high sound pressures. Thereby the microphone has a large dynamic range, but—as recalled—unfortunately also a relatively low sensitivity. Therefore, in typical configurations, the speech signal will appear as an electrical signal with a small magnitude. In order to optimize the signal-to-noise ratio for subsequent signal processing, an amplifier with a relatively large gain is required. This scenario illustrates a conventional application which operates properly for speech signals.

However, as mentioned above, the microphone may receive a very loud sound pressure. Such a loud sound pressure may come from the (more distant) surroundings of the microphone and is commonly denoted background noise. Such background noise can be (loud) sound pressures originating from a gust of wind (denoted wind noise), from machines generating tones, band-limited noise or quasi white noise. Such noise signals may appear within, below or even above the frequency band of a speech signal. In any event such signals may degrade the perceived quality.

However, the situation is further complicated when the microphone is used in battery operated devices with limited supply voltage level. As mentioned above, the amplifier has a relatively large gain. Thus, when a loud noise signal is present, converted into an electrical signal and then amplified with a large gain the head room or dynamic range available for the speech signal quickly vanishes as the amplitude of the noise signal increases.

Often the noise signals cause not only limited dynamic range, but also amplitude clipping. Since the speech signal often is weak compared to the noise signal, the speech signal will be lost for the periods of time—up to several hundreds of milliseconds or more—where clipping takes place. This severely degrades quality. Severe clipping due to overload of the amplifier may cause the amplifier to cease operating as an amplifier for several seconds of time. Thus, the large dynamic range of the microphone and the limited dynamic range of the amplifier introduce a risk of clipping in an environment where large magnitude noise signals may occur.

The theoretical limit for the signal-to-noise ratio, SNR, which is related to dynamic range, of a battery operated amplifier can be approximated by the below expression:

$$SNR = \frac{{V}_{dd}^{2} / 8}{kT / C}$$

where Vdd is the supply voltage to the amplifier, k is Boltzmans constant, T is temperature in degrees Kelvin, and C is a capacity representative of the bandwidth of the amplifier. In terms of seeing how the signal-to-noise ratio can be improved kT is constant. Thus, the signal-to-noise ratio is proportional to the square of the supply voltage.

A limited battery supply voltage is therefore in practical situations considered a bar against an improved signal-to-noise ratio.

### Loops—Stability

In search for configurations that meet the demand for improved quality, different types of feedback configurations have been proposed. In analogue signal conditioning circuits, feedback configurations for improving linearity and bandwidth, for filtering and for removing DC offsets have been proposed. However, these configurations have a fixed structure and function. Their function is, due to die area constraints, limited. In digital signal conditioning circuits, feedback configurations have not been fully utilized since digital feedback configurations are relatively complex and occupy, for price sensitive products, too much die area when its performance is compared to analogue solutions.

Use of feedback configurations may, however, give problems with respect to stability. In general, a relatively large open loop gain gives a relatively good suppression of noise and less distortion. But a relatively large open loop gain increases the risk of the feedback configuration becoming unstable.

In the frequency spectrum, open loop gain decays towards higher frequencies. At a certain frequency, gain will have dropped to 0 dB. If, at this or any lower frequency, the phase of the open loop transfer function is shifted more ±180 degrees the loop is potentially unstable. For sampled systems, using a Nyquist sampling rate, it is problematic to achieve sufficiently good suppression of noise and sufficiently low distortion. This is due to the situation that higher-order filters are needed to provide sufficient cut-off of signal components above the Nyquist frequency to provide sufficient anti-aliasing and such high order filters introduce phase shifts of ±180 degrees or more. These conditions limit the available open loop gain and hence the ability to suppress noise and distortion.

In the below description, the term audio band is used. In the prior art this term has various definitions depending on its context. However, in the below it will be used to designate a frequency band which typically has a lower corner frequency of 20 Hz to 500 Hz and an upper corner frequency of 5 KHz to 25 KHz. The specific definition of the band represents a design criterion, but for the below description it should be read with this broad definition.

### Related Art

WO 2005/07646-A1 discloses a preamplifier for a capacitive transducer. The preamplifier is configured with a differential input stage to receive a signal from a transducer at its non-inverting input and a feedback signal at its inverting input. The feedback signal is provided via feedback filter that receives its input from the output of the preamplifier. The feedback filter is configured as a low-pass filter which makes the preamplifier and feedback filter in combination appear as a high-pass filter. An analogue-to-digital converter is coupled to receive the analogue output signal from the preamplifier and to provide a digital output signal. This configuration is expedient for providing relatively high input impedance, relatively high signal-to-noise ratio, and to provide relatively fast settling when an undesired pulse with large amplitude low-frequency components has appeared in the input signal. In general, the dynamic range with respect to a desired audio signal is improved. However, since the analogue feedback filter occupies a substantial area on a chip die, the demands in terms of low cost cannot be fully met. Further, due to the fixed structure of the filter, its filter properties cannot be changed e.g. its characteristic poles and zeroes cannot be changed. Moreover, acoustic noise present in the audio band (also denoted in-band noise) cannot be removed without damaging a desired audio signal severely.

EP 1 553 696 discloses an amplifier circuit for capacitive transducers. The amplifier circuit comprises a preamplifier to receive a transducer signal at its input and to provide an output signal. Moreover, a DC-servo is provided by means of a difference amplifier which receives the output signal and a reference voltage signal. The difference amplifier provides a feedback signal to the input of the preamplifier via two cross-coupled diodes. Thereby DC compensation is provided at the input of the preamplifier. The two cross-coupled diodes are provided as a measure to couple the feedback signal back to the input of the preamplifier while avoiding excessive decoupling of the signal input from the capacitive transducer. Since the feedback signal is provided via cross-coupled diodes, the feedback is operational only for DC and signals at very low frequency. The amplifier circuit is configured with fixed filter properties of the feedback system and is not suitable for being changed during operation.

U.S. Pat. No. 5,796,359 discloses a data conversion system configured with a comparator to receive an analogue input signal and an analogue feedback signal and provides a comparator output. The comparator operates in a non-linear saturation mode. When the analogue input signal exceeds the analogue feedback signal, the comparator produces a logic one, and when not a logic zero. Output of the comparator is provided as input to a pulse-width modulator so as to provide a pulse-width modulated output signal. The pulse-width modulated output signal is provided to an RC-network that filters the signal to provide the feedback signal. This configuration is a low-cost analogue-to-digital converter, which provides only weak shaping of switching noise introduced by the comparator and hence only a poor signal-to-noise ratio is achievable. Further, the converter does not provide means to filter an input signal in the frequency range where the system operates as an analogue-to-digital converter. Consequently, the converter is not suited for enhancing a desired signal relative to an undesired signal that interferes with the desired signal. Since the converter is basically an analogue converter, although non-linear processing is used, the converter is not compatible with digital signal processing. Thus, due to die area constraints, its signal processing capabilities are limited.

U.S. Pat. No. 6,956,517 discloses an analogue-to-digital conversion system suitable for multi-channel systems. The conversion system uses a digital-to-analogue converter to provide negative feedback to cancel undesired signals at the input of the analogue-to-digital converter. Thereby the effective dynamic range of an analogue-to-digital converter can be extended. However, this conversion system does not comprise a gain stage suitable for coupling to a capacitive transducer. The feedback circuit will cause excessive attenuation of the signal level from a capacitive transducer coupled to the input.

U.S. Pat. No. 6,806,756 discloses an analogue signal conditioning circuit for processing an analogue signal generated by a sensor to remove DC offset. The circuit comprises an operational amplifier that receives an analogue input signal from the sensor and an analogue feedback signal at its inverting input. The feedback signal is provided by a feedback circuit with an analogue-to-digital converter, a digital controller and a digital-to-analogue converter—the latter to provide the feedback signal via a resistor to the inverting input of the operational amplifier. Despite being configured to remove DC offsets only, this configuration is far from optimal in terms of noise. This circuit is not suitable for a capacitive transducer since the both the analogue and digital feedback circuits will cause excessive decoupling of the signal input from the capacitive transducer. It is clear that the feedback is provided as a measure to remove DC offsets and that the circuit's sampling principle limits the application to remove undesired DC signals only.

Despite the contribution to the technical field by the above disclosures it remains a problem to provide a signal conditioner that can be manufactured at low cost and operated at a low supply voltage and at low current consumption while providing a high quality output signal in terms of low acoustical and electrical noise and high dynamic range.

### SUMMARY OF THE INVENTION

According to a first aspect of the invention, there is provided a semiconductor die with an integrated circuit providing a signal conditioner for a capacitive transducer. The semiconductor die comprises a gain stage configured to receive an analogue transducer signal on a first input and a feedback signal on a second input. An analogue-to-digital converter is coupled to receive an output signal of the gain stage and to provide a digital signal. The feedback signal is provided via a digital-to-analogue converter and a digital signal processor receiving the digital signal.

Since a feedback loop is established, where the feedback signal is provided at the second input of the gain stage and where the analogue transducer signal is electrically coupled to the first input of the gain stage and the output of the gain stage is operationally responsive to both of the feedback signal and analogue transducer signal, it is possible to provide a feedback signal adapted to cancel undesired signals from the capacitive transducer at an early stage of processing the analogue transducer signal. Since cancelling of the undesired signal takes place at the input stage of the gain stage which also serves to isolate the capacitive transducer from loading the first input of the input stage, and to amplify the transducer signal, it is possible to cancel undesired signal components despite the transducer signal being extremely dynamic in nature and despite the output signal of the capacitive transducer being, due to its high output impedance, very sensitive to relatively low capacitive or relatively low resistive loading of the transducer.

The analogue transducer signal and the feedback signal are provided at two different or separate inputs of the gain stage preferably acting as the inverting input and the non-inverting input respectively to form, at the output of the gain stage, a signal representative of a signal difference between the first and second inputs.

Due to the digital implementation or nature of the feedback loop, it is possible to integrate the feedback loop within a small area. Compared to a corresponding analogue solution with a die area of 250 μm×250 μm, in a so-called 0.18 μm CMOS process it is estimated that the above feedback loop can be implemented within a die area occupation of 70 μm×70 μm. In general, due to the digital signal processing of the feedback signal die area can be saved. For signal processing involving implementation of signal transfer functions with poles and/or zeroes at low frequencies—say below 100 Hz—up to about 30-40% die area can be saved. Further, power consumption is reduced since less area is occupied and since less bias current is required for digital signal processing.

By means of digital signal processing the feedback signal and hence the output signal can be controlled to suppress undesired signal components in the electrical output of the transducer. This is beneficial since a signal from the capacitive transducer may comprise substantial, time-varying dynamic range caused by an undesired signal. Since clipping usually occurs at the output, the feedback signal can be applied, at the input stage, to suppress even a strong or high-level undesired signal.

When strong, undesired signal components are suppressed the signals being the most dominant source to clipping are suppressed. Consequently, the dynamic range of the gain stage and the analogue-to-digital converter can be utilized more efficiently to provide signal conditioning of a desired signal and the signal-to-noise ratio thereof is improved. A trade-off in terms of clipping and signal-to-noise ratio remains, but since strong undesired signals are suppressed, the gain of the input stage and thus the signal-to-noise ratio can be increased.

Since the feedback signal is provided at different input of the gain stage than the analogue transducer signal, the feedback signal can be provided with without additional decoupling of the analogue transducer signal. It is generally desired to couple as much of the signal provided by the transducer to a preamplifier since the signal swing will more or less determine the maximally achievable signal-to-noise ratio. This leads to a problem of where to apply a feedback signal when the preamplifier is a part of the forward path of a loop established by a feedback circuit since the feedback circuit can easily cause such decoupling and hence cause reduction of the achievable signal-to-noise ratio. However, when the feedback signal and the analogue transducer signal are provided at different inputs of the preamplifier, a direct path from the capacitive transducer to the input of the preamplifier can be established. Thereby a measure to reduce decoupling is established without reducing the signal-to-noise ratio.

In an embodiment a resolution of the digital-to-analogue converter is higher than a resolution of the analogue-to-digital converter. In the present specification and claims, the term “resolution” is a measure of the level of desired signal output of the digital-to-analogue or analogue-to-digital converter, as the case may be, to a total noise and distortion output measured across a bandwidth of 20 Hz to 20 kHz with a 1 kHz input signal at a level of full scale (FS)—20 dB.

Thereby it is possible to use of an analogue-to-digital converter with a higher noise level than the noise level provided at the first input of the signal conditioner because the feedback loop is operative to suppress noise generated by the relatively low resolution analogue-to-digital converter in accordance with a loop gain. According to a number of embodiments of the invention, the resolution of the digital-to-analogue converter in an audio bandwidth between 20 Hz and 20 kHz is more than 6 dB, or more than 10 dB, or more than 20 dB higher than the resolution of the analogue-to-digital converter.

The signal-to-noise ratio at the output of the signal conditioner is, for large loop gains, mainly determined by the digital-to-analogue converter. Increasing loop gain of the signal conditioner leads to improved suppression of the noise generated by the analogue-to-digital converter. This suppression is operative at loop gains greater then 0 dB. Consequently, when the digital-to-analogue converter is configured to have a higher resolution or better signal-to-noise ratio than the analogue-to-digital converter, the analogue-to-digital converter can be implemented at a level of complexity which is relatively low compared to a situation where the analogue-to-digital and digital-to-analogue converter are designed with approximately similar resolution or signal-to-noise level. Consequently, die area and costs can be saved.

In an embodiment, gain of the signal conditioner is controlled by the digital signal processor. The gain can be controlled by changing the gain of the digital signal processor e.g. in response to the level of the signal input to the digital signal processor. Gain can be controlled according to a so-called Automatic Gain Control scheme to provide more uniform amplitude levels of the signal output from the signal conditioner despite substantial variations in amplitude levels of the signal input to the signal conditioner. This feature if often referred to as dynamic range compression.

In an embodiment the resolution of the digital-to-analogue converter is higher than the resolution of the analogue-to-digital converter. One way to save die area and cost is to implement the analogue-to-digital converter with a lower resolution than the digital-to-analogue converter.

In order to ensure compatibility and reduce complexity of especially cost-optimized circuits, a common clock frequency is conventionally applied to different digital signal processing units of a signal conditioner. Further, since in general power consumption is proportional to the rate of the clock frequency and since the achievable signal-to-noise ratio is inversely proportional to the clock frequency, signal-to-noise ratio is traded for power consumption. A solution, however, is to operate the digital-to-analogue converter at a higher clock frequency higher than the clock frequency of analogue-to-digital converter. Preferably, at least one, and possibly both, of the analogue-to-digital converter and the digital-to-analogue converter is operated at an over-sampled sampling rate such as a sampling rate above 48 kHz, or more preferably above 256 kHz or even more preferably above 1.024 MHz.

Thereby the overall signal-to-noise ratio of the signal conditioner with the feedback loop configuration is improved. This improvement is achievable even if the analogue-to-digital converter is not operated at the higher clock frequency. An improved signal-to-noise ratio is achieved at only a marginal increase of the power consumption in an advantageous manner. Operating the converters at different clock frequencies can improve flexibility of the signal conditioner. For example the analogue-to-digital converter may operate at a clock-frequency compatible with another circuit receiving the digital signal, whereas the digital-to-analogue converter may operate at a clock frequency which is not necessarily compatible with the other circuit.

When the analogue-to-digital converter and the digital-to-analogue converter are both operated at an over-sampled sampling rate as mentioned above, the gain-bandwidth product of the loop is improved and stability of the loop is improved. Sampling is the reduction of a continuous signal to a discrete signal. At the Nyquist rate i.e. at a frequency of twice the bandwidth or highest frequency of the signal being sampled perfect reconstruction is possible. Oversampling is the process of sampling a signal with a sampling frequency significantly higher than twice the bandwidth or highest frequency of the signal being sampled. An over-sampling rate of four or more e.g., eight, sixteen, thirty-two, or sixty-four is found to improve the gain-bandwidth product and thus stability. Over-sampling is preferably performed with a sampling frequency situated within the range 0.1 MHz to 10 MHz e.g. at 2.4 MHz.

According to a particularly advantageous embodiment of the invention, the feedback loop or path, formed from an input of the analogue-to-digital converter to the feedback signal at the second input of the gain stage, has a latency or time delay, measured at 1 kHz, that is smaller than 50 μS, preferably smaller than 20 μS, or even more preferably smaller than 5 μS.

This range of small time delays of the feedback loop is particularly advantageous in embodiments of the invention where at least one of the analogue-to-digital converter and the digital-to-analogue converter comprises a single level or multi-level sigma-delta converter. The low latency or time delay through the feedback loop improves stability of the signal conditioner due to introduction of a relatively small phase shift in the loop gain function and hence room for a larger loop gain. This in turn improves performance of the signal conditioner. According to one embodiment of the invention, the gain stage is designed with significant open loop small signal gain at 100 Hz such as an open loop small signal gain larger than 40 dB, for example between 40 and 100 dB.

The gain stage may advantageously comprise or be configured as an integrator. Thereby an increasing loop-gain is achieved at lower audio frequencies. This in turn gradually improves the signal-to-noise ratio of the signal conditioner towards lower frequencies. A desired higher low frequency loop gain can be achieved without compromising the stability of the loop.

Low latency can be achieved by processing samples from the analogue-to-digital converter, in the digital signal processor, and in the digital-to-analogue converter at the over-sampled rate. Alternatively, to release the digital processor from processing at the full over-sampled rate, a decimator with an anti-aliasing filter can be inserted in a signal path between the digital signal and the digital signal processor and adapted to reduce the sampling rate and supply samples to the digital signal processor a reduced rate. A decimation factor of 16, 10, 4 or 2 or another decimation factor below approximately 16 gives a low latency, other things being equal.

In an embodiment the gain stage comprises a differential input stage. Since the impedance between inputs of a differential input stage very large, often approaching infinity, the feedback loop imposes virtually no load on the first input coupled to the analogue transducer signal. Consequently, improved input impedance is obtained which efficiently reduces any transducer signal loss from the transducer improving the sensitivity of the transducer and the signal conditioner in combination. When the feedback signal takes the form of an undesired signal, comprised by the signal from the transducer, this undesired signal is applied to the gain stage as a common-mode signal, whereas a desired signal also comprised by the analogue transducer signal is applied to the gain stage as a differential-mode signal. Since the differential input of the gain stage has a very low common-mode gain, but a large differential-mode gain, the interfering signal can be effectively suppressed. The differential input stage is operatively coupled to the output of the gain stage.

Alternatively, the gain stage comprises a transistor coupled to receive the signal from the capacitive transducer and the feedback signal at two respective terminals of the transistor. In case the transistor is a CMOS type, the signal from the transducer can be supplied to the gate terminal and the feedback signal can be supplied at the source terminal. This is expedient since the transducer is a capacitive transducer supplying a voltage signal and since the feedback signal can be provided as a current signal. Consequently, a very cost effective solution is provided.

For all architectures or configurations of the gain stage, the first input of the gain stage preferably has an input impedance larger than 1 GΩ such as larger than 10 GΩ, or preferably larger than 100 GΩ. This level of input impedance at the first input may advantageously be provided in the entire audio frequency range from 20 Hz to 20 kHz.

When the digital signal processor is configured with a digital low-pass filter, the signal conditioner implements a high-pass filter to suppress low frequency signals from the transducer. This will prevent the amplifier from overloading at its output (which would result in clipping of the output signal) when the transducer is exposed to acoustical signals, thermal signals or movements (vibrations) with large undesired low-frequency signal components. Overloading of the input is generally not as big a problem as output overloading since the input signal has not been amplified and thus has lower amplitude than the output signal.

The feedback circuit can be implemented as a low-pass filter so as to provide high-pass filter transfer function of the signal conditioner. The signal from the transducer and the feedback signal are provided at two different terminals of the gain stage. The two different terminals of the gain stage are coupled to each other e.g. like the drain and gate of a CMOS transistor are coupled or like the gates of a pair of transistors in a differential gain stage are coupled. Thereby the input terminal at which the signal from the capacitive transducer is received is protected from low or varying impedance of the feedback circuit or network. Thus, since the transducer signal input to the gain stage is not exposed to the only slowly decaying impulse response of the feedback circuit (which may be a low-pass filter) and since infrasound signal components with excessive amplitudes are effectively suppressed, such infrasound signal components (and DC like components) are effectively prevented from overloading the preamplifier (which would otherwise cause serious distortion). In this way small in-band signals (i.e. signals in the pass band of the highpass filter or bandpass filter realized by the signal conditioner) can be amplified while large low frequency signals are suppressed. This greatly improves the achievable gain of the preamplifier without causing overload. It would in general not be possible to repair a signal in a downstream signal processor since important information in the signal would be lost.

When the digital signal processor is configured with a digital low-pass filter and the digital low-pass filter is controlled in response to the input signal, i.e. made adaptive, it is possible to improve the achievable signal quality at the output of the signal conditioner. For example, when a strong signal is present, the filter is controlled to suppress the undesired signal, but at the cost of reducing bandwidth of the desired signal. When the strong signal is not present, the filter is controlled to suppress an undesired signal to a smaller extent, but to improve the bandwidth available for the desired signal.

In an embodiment of the invention, the digital signal processor comprises a signal estimator configured to estimate an amplitude and/or phase of a dominating signal component of the analogue transducer signal. A signal generator is controllable by the signal estimator to generate the feedback signal with an amplitude and/or phase determined on basis of the amplitude and/or phase of the dominating signal component. The signal estimator may operate directly on the transducer signal or on a processed version thereof such as an amplified, buffered, digitized or amplitude limited signal derived there from. The dominating signal component may comprise a single fundamental frequency of the analogue transducer signal or a combination of the fundamental frequency and a series of harmonics.

Thus, the signal generator is controlled by the signal estimator to provide a feedback signal to the gain stage via the digital-to-analogue converter. Since the feedback signal is provided as a negative feedback signal to the gain stage, the signal transfer function from input to output of the signal conditioner will comprise a gain notch or a plurality of notches located at the fundamental frequency of the dominating signal component and/or located at the series of harmonics of the fundamental frequency. This is particularly advantageous in situations where strong stationary or quasi-stationary periodic infrasonic, audible or ultrasonic sound signals are present in the analogue transducer signal. Thereby, undesired signals e.g. from machines with rotating parts in vicinity of a microphone can be effectively notched out.

In an embodiment of the invention, the signal estimator is configured to detect a time duration of the dominating signal component by performing an analysis over periods of time longer than an expected duration of voiced speech cues of human speech. Desired signals—which may be speech—and which should not be attenuated in any significant comprises quasi-stationary oscillating signals. However, at least in the situation where a desired signal can be characterized as speech and where an undesired signal or interfering signal has quasi-stationary components with duration of more than half a second, a few seconds, minutes or more—it is possible at least to some extent to distinguish signal components from interfering signals by performing an analysis of the analogue transducer signal over periods of time longer than an expected duration of voiced speech. By identifying such long lasting or quasi-stationary interfering signals it is possible to adapt the digital signal processor to selectively notch out or suppress these.

Therefore, in an embodiment, the signal estimator is adapted to estimate the time duration of dominating signal components by performing an analysis of the analogue transducer signal over a time period longer than for example 100 ms, or 200 ms, or 300 ms, up to time periods of time of a few seconds.

In certain embodiments of the invention, the signal estimator is configured to detect the time duration of the dominating signal component by auto-correlation and/or spectral analysis. The signal estimator may be configured to identify from an auto-correlation function and/or the frequency spectrum which and whether interfering signals are present in the analogue transducer signal and to repeat calculation of the auto-correlation function and/or frequency spectrum to determine whether an interfering signal is persistent. In case the interfering signal is of persistent nature, the signal generator is controlled to supply or output a signal corresponding essentially to the estimated interfering signal. Whereas, if the interfering signal has shifted in frequency and/or phase and/or amplitude, estimation restarted until an interfering signal persists in frequency and/or amplitude and/or phase for more than for example 100 ms, or 200 ms, or 300 ms, or up to 2 or 3 seconds.

The signal estimator is preferably adapted to control the amplitude and/or phase of the feedback signal based on the detected time durations of the dominating signal component.

In an embodiment of the invention, the digital signal processor is configured with an adaptive filter to suppress a component of the analogue transducer signal that has autocorrelation values about equidistant delays. The autocorrelation values significantly represent a persisting oscillation of the analogue transducer signal. A desired signal like human speech will have an auto-correlation which for auto-correlation windows larger than a few hundreds of milliseconds may show correlation larger than zero, but it will generally speaking only show oscillating components for small delays. An interfering or undesired signal with oscillating components that persist for more than 100 ms or more will significantly comprise autocorrelation values about equidistant delays starting at a delay corresponding to the period time of the fundamental frequency of the interfering signal. The person skilled in the art of adaptive filters will know how to apply peak search algorithms or other algorithms to identify periodic signals and how to make an adaptive filter suppress signals not showing a consistently oscillating behaviour over a period of time. The period of times may have a duration that is longer than the expected duration of quasi-stationary speech cures, e.g. with a duration that is longer than 100 ms, 200 ms, 300 ms, up to periods of time of a few seconds duration.

In accordance with a second aspect of the invention, there is provided an electroacoustical transducer comprising a semiconductor die according to any of the above-described embodiments and arranged inside a transducer housing. A transducer element, for example a capacitive transducer element, of a condenser microphone, disposed inside the transducer housing and operatively connected to the first input of gain stage to supply the analogue transducer signal.

### BRIEF DESCRIPTION OF THE DRAWING

A more detailed description of embodiments of the invention is given below with reference to the drawings, in which:

FIG. 1 shows a transducer and a signal conditioner;

FIG. 2a depicts a desired or target signal;

FIG. 2b depicts an undesired or interfering signal;

FIG. 2c depicts a desired signal superposed on an undesired signal;

FIG. 2d depicts a clipped signal;

FIG. 2e depicts a desired signal superposed on a subdued interfering signal;

FIG. 3a depicts the frequency spectrum of a desired and a low-frequency interfering signal;

FIG. 3b depicts the frequency spectrum of a desired signal and an in-band interfering signal;

FIG. 4 shows a capsule with a transducer and an integrated circuit;

FIG. 5 shows a signal conditioner with a preamplifier shown in detail;

FIG. 6 shows a signal conditioner with an analogue feedback filter;

FIG. 7 shows a signal conditioner with a switched capacitor digital-to-analogue converter;

FIG. 8 shows a shows a transducer, a signal conditioner and an external circuit;

FIG. 9 shows an embodiment of the digital signal processor; and

FIG. 10 shows an embodiment of the digital signal processor.

### DETAILED DESCRIPTION

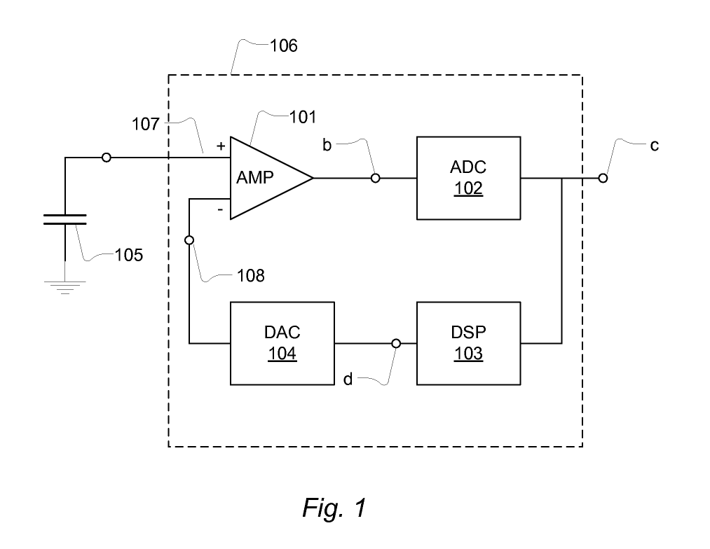

FIG. 1 shows a transducer and a signal conditioner 106. The transducer is a capacitive transducer 105 e.g. forming part of a condenser microphone. The capacitive transducer 105 converts a type of energy e.g. a sound pressure to an analogue electrical signal. The analogue transducer signal may comprise a desired signal and an interfering or undesired signal. The capacitive transducer 105 is coupled to a gain stage in form of preamplifier AMP, 101 that has an output terminal and a non-inverting input terminal 107 and an inverting input terminal 108 which is coupled to a feedback signal provided by a digital-to-analogue converter 104. The preamplifier is configured to receive input signals at the input terminals as a differential input and provide the output signal in response to the differential input. In general the preamplifier 101 is characterized by differential inputs that exhibit high input impedance compared to the output impedance at the output terminal. In an open loop the preamplifier 101 is characterized by a large small signal open loop gain, such as gain larger than 40 dB or 60 dB or even 100 dB measured at 20 Hz. The preamplifier may comprise a so-called operational amplifier.

The output of the preamplifier 101 is coupled to an analogue-to-digital converter ADC, 102. The analogue-to-digital converter 102 receives an amplified version of analogue transducer signal from the preamplifier and provides a digital output signal. The digital output signal is also considered the output of the signal conditioner since it represents the desired signal in the digital domain, but in a conditioned form. The digital output signal may be formatted in accordance with a digital transmission protocol such as IIS or IIC etc.

In an embodiment, the digital signal processing that takes place in a feedback path or loop from output of the amplifier 101 at node ‘b’ to the feedback signal provided at the output of the digital-to-analogue converter 104 at node 108. the digital-to-analogue converter 104 is of a type operating at an over-sampled rate. Thereby it is possible to improve the gain-bandwidth product of the feedback loop and hence secure stability of the loop in a cost-efficient manner. In an embodiment, the analogue-to-digital converter 102 and/or the digital-to-analogue converter 104 comprises a sigma-delta converter. An over-sampling rate of four or more e.g. eight, sixteen, thirty-two, or sixty-four is found to improve the gain-bandwidth product and thus stability.

The output of the analogue-to-digital converter 102 is passed to a digital signal processor 103. The digital signal processor is configured to provide a digital output signal which is a digital estimate of the interfering signal. The digital output signal is passed as an output signal of the digital signal processor 103 to the input of a digital-to-analogue converter DAC, 104. The output of the digital-to-analogue converter 104 is coupled to the input of the preamplifier 101, but the transducer and the output of the analogue-to-digital converter 102 are coupled separately to respective ones of the first input and the second input. Thereby a loop is formed, where a signal that represents an undesired signal is provided as the feedback signal so as to subtract the interfering signal from the desired or target signal provided by the capacitive transducer 105. The loop is configured such that negative feedback is provided to the preamplifier 101. It is shown that the transducer 105 is coupled to the non-inverting input 107 and the analogue-to-digital converter 102 is coupled to the inverting input 108, i.e. (−) terminal on the preamplifier 101.

Reduction of the noise level output from the signal conditioner 106 is generally most efficiently implemented by improvement of the digital-to-analogue converter 104. From a noise level perspective this can be achieved in different ways. It can be achieved by increasing the number of quantization levels in case the digital-to-analogue converter 104 is of the sigma-delta type. It can also be achieved by increasing the number of bits in case the digital-to-analogue converter 104 is a multi-bit type converter. The multi-bit converter may have an output stage where an analogue signal is provided by individually controlling a number of current sources arranged in a parallel configuration. Alternatively, the analogue signal at the output of the multi-bit converter may be provided by a switched capacitor circuit arranged with capacitors that are charged and discharged to deliver a charge proportional to the digital signal.

Other devices such as resistor networks may also be used as means to convert the digital signal at node (d) to an analogue feedback signal. So-called mismatch noise shaping can be implemented to compensate for inaccuracies in amounts of current or charge provided by the current sources or capacitors in a switched capacitor circuit. According to mismatch noise shaping, controlled but random selection of the current sources or capacitors is applied to reduce the effect of the inaccuracies generating distortion in the form of tones at higher frequencies or increased in-band noise.

Especially as undesired signals may occur with large amplitudes and as, typically, the linear range of the differential input of the amplifier is limited to about +/−100 mV, there is a risk that distortion originating from the input signal being exposed to clipping and noise occurring at higher frequencies is folded down to an audio band where distortion is the result.

Since noise originating from the analogue-to-digital converter 102 is suppressed proportionally to the amount of loop gain, an embodiment comprises a preamplifier with a pole located at a low frequency to make the amplifier work as an integrator throughout a portion or the entire audible frequency range from 20 Hz to 20 kHz with a relatively large gain at low frequencies and decaying towards higher frequencies at 6 dB per octave or more. The feedback configuration of the signal conditioner will, other factors being equal, give the signal conditioner a flat frequency response for desired signals. The pole or poles can be located at subsonic frequencies of say 1 Hz or lower or at higher frequencies say at 10 Hz or higher.

When oversampling is used in the feedback loop of the signal conditioner 106, it is possible to achieve a relatively low latency or small time delay through the feedback loop formed from an input, node (b) of the analogue-to-digital converter 102 to the feedback signal at the second input (08 of the preamplifier 101. The time delay is preferably smaller than 50 μS, such as smaller than 20 μS, or preferably smaller than 5 μS for example measured at 1 kHz. The low time delay is highly advantageous because it allows the application of a very high loop gain in the feedback loop around the signal conditioner 106 to improve linearity and noise suppression of noise sources inside the feedback loop without introducing stability problems. Furthermore, using oversampling in the feedback path makes it possible to filter out quantization noise generated by the digital-to-analogue converter 104 by means of a simple low-pass filter which has only one or a few poles. Moreover, use of oversampling in the feedback path makes it possible to realize the low-pass filter with a relatively broad pass band (i.e. with a relatively high cut-off frequency) and hence to reduce latency through the filter. In an embodiment the low-pass filter is an analogue filter or switched capacitor filter.

As previously mentioned, in an embodiment the digital signal processor is configured to implement a digital low-pass filter which in turn makes the signal conditioner 106 operate as a high-pass filter. The high-pass filter is designed to suppress interfering signals like low-frequency or sub-sonic acoustical signals picked up by the capacitive transducer 105. Such low-frequency or subsonic signals may have significantly different energy content at low frequencies say below 400 Hz, 100 Hz, 50 Hz, 20 Hz, 5 Hz or even at lower frequencies. However, it is desired to pass a desired signal even at low frequencies. Consequently, in an embodiment, the cut-off characteristic of the high-pass filter is adjusted according to the energy content in one or more frequency bands at low frequencies. The cut-off characteristic is adjusted by controlling frequency location of one or more lower cut-off frequencies and/or an order of the high-pass filter. Operatively, the high-pass filter is determined by the low-pass filter of the digital signal processor. Thus, the high-pass filter characteristic of the signal conditioner 106 is controlled by setting the properties of the low-pass filter (mutatis mutandis) as understood by a person skilled in the art. In an embodiment, the cut-off characteristic of the high-pass filter is adjusted to pass relatively more signal energy in a frequency band when energy content in that frequency band in the signal input to the digital signal processor is below a predefined threshold value compared to the situation where energy content in that frequency band in the signal input to the digital signal processor 103 is above the predefined threshold value. The frequency band can be a band from e.g. DC to 5 Hz, DC to 10 Hz, DC to 20 Hz or another band at low frequencies below for example 500 Hz.

The digital estimate of the interfering signal can be provided in different ways. The digital estimate can be provided by the digital signal processor in an embodiment where it is configured with a digital high-pass filter.

The digital estimate can be provided by the digital signal processor in an embodiment where the digital signal processor is configured with a signal estimator that estimates a fundamental frequency and one or more harmonic components in the analogue transducer signal or a signal derived there from.

The digital estimate can be provided by the digital signal processor 103 in an embodiment where the digital signal processor 103 is configured with an adaptive filter to suppress a component of the input signal that has a relatively weak autocorrelation relative to a component that has a relatively strong autocorrelation. When the digital estimate is converted to an analogue signal and provided as a feedback signal, the component that has a relatively strong autocorrelation will be suppressed in the signal output from the signal conditioner.

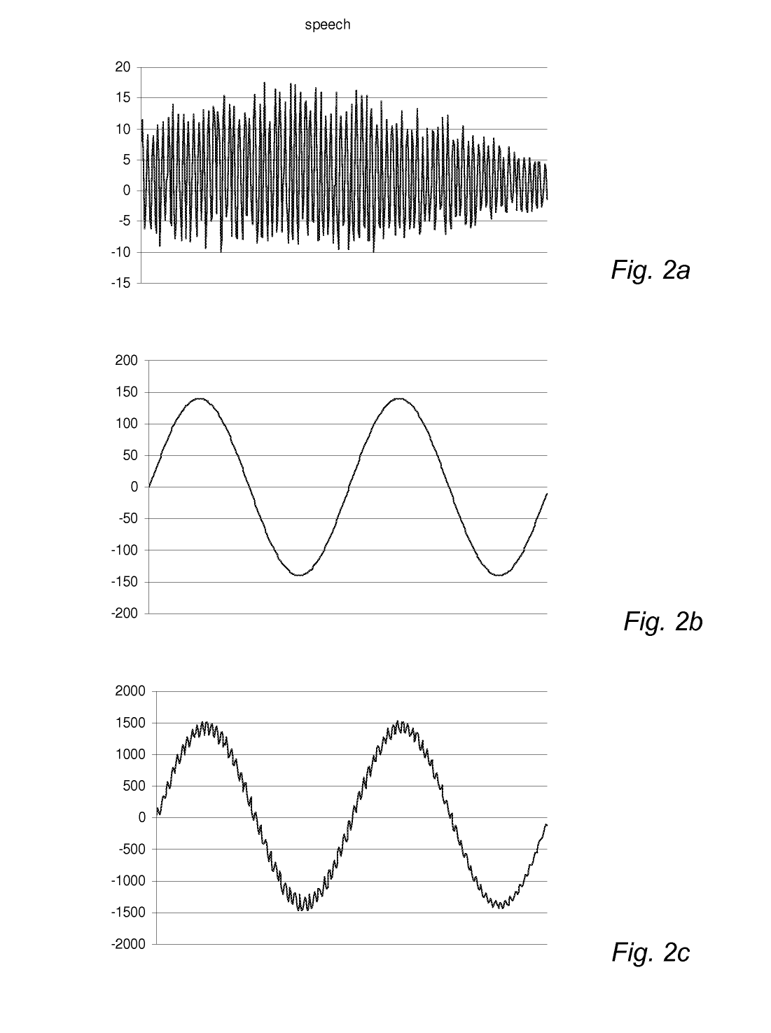

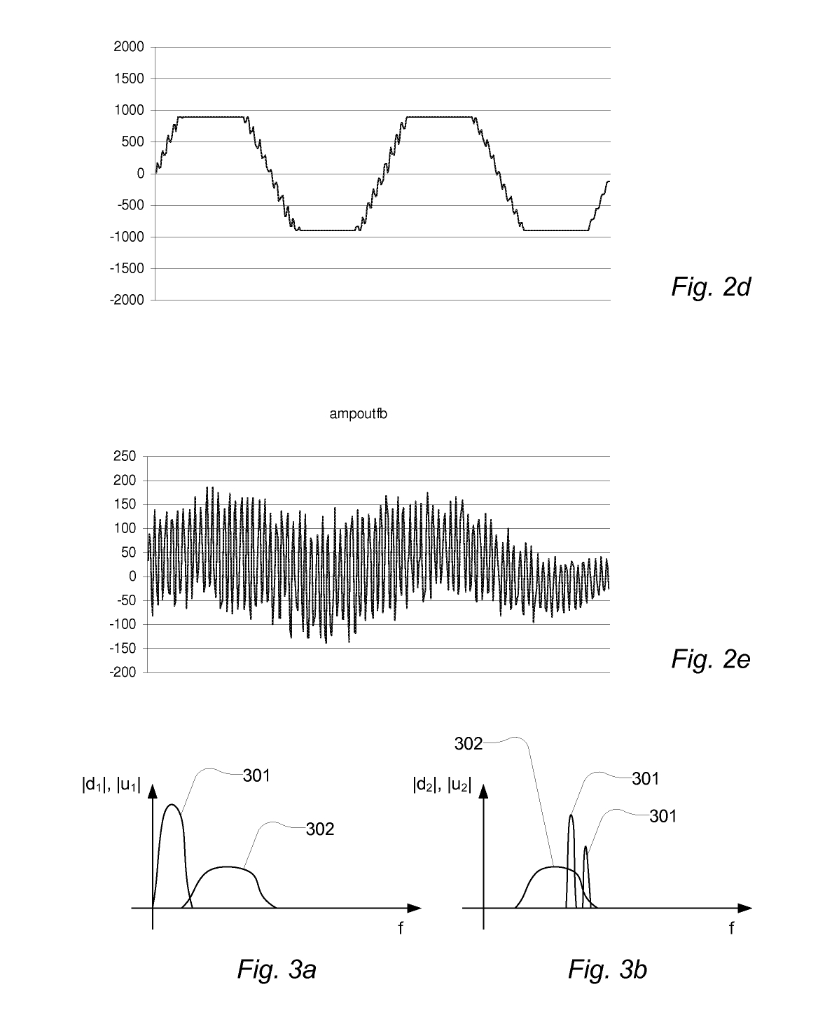

FIGS. 2a through 2d depict different signals related to different nodes 107, (b), (c), (d) and 108 of the signal conditioner shown in FIG. 1.

FIG. 2a depicts a desired or target signal. This target signal may be present at node 107 of the signal conditioning circuit 106 shown in FIG. 1. The target signal is shown over a certain time interval, T, In case the transducer is a condenser microphone, the signal represents sound pressure over time, e.g. caused by human speech. A peak magnitude of the signal is about +/−15 mV and the duration of the shown portion of the signal may be say 400 ms. However, often the transducer is responsive to signals that interfere with the target signal such as a speech signal. Since the transducer is responsive inseparably to both the desired signal and the undesired signal, the signals are mixed or blended. In many situations this takes place within a range where the transducer operates to convert energy substantially linearly. In such situations it may be assumed that the desired and undesired are substantively additively added.

FIG. 2b depicts an exemplary interfering signal. This interfering or undesired signal may be present at node 107 of the circuit shown in FIG. 1. The undesired signal is depicted at the same time scale as the desired signal, but as a periodical signal with a sinusoidal form and amplitude of about 150 mV. Thus, the undesired signal appears to be stronger than the desired signal and to have a far stronger auto-correlation.

The undesired signal can be a signal that is periodical over a certain time interval of e.g. 10 ms or more. Since the conversion of physical energy by the transducer is bandwidth limited, the undesired signal will be bandwidth limited. Within this bandwidth limitation the undesired signal can take any form. The undesired signal need not be a periodical signal—it can also take the form of a pulse or damped oscillation.

The definition of what the undesired signal is depends on the application of the transducer and the signal conditioner. In case the transducer is a microphone, the desired signal can be a speech signal from a human being and the undesired signal can be e.g. noise with strong tones generated by a machine in the vicinity of the human being. The strong tones can be located in the signal band of the speech signal thus strongly interfering with the speech signal.

FIG. 2c depicts a desired signal superposed on an undesired signal. This signal illustrates the output signal of an amplifier with a very large dynamic range and coupled to receive the desired and undesired signal as they would be integrated by the microphone. The gain of the preamplifier is indicated to be about 10 times or 20 dB. Given the amplitude of the undesired signal the output signal swing is about +/−1500 mV.

Thus, in the transducer the desired signal and the interfering signal are additively mixed. Since the transducer often can be regarded a signal generator generating a weak signal at relatively high output impedance, a preamplifier is needed to make the signal from the transducer appear with a stronger signal at lower output impedance. Since a preamplifier has a limited signal swing at its output and since generally a large gain factor is desired to amplify the weak desired signal, there is a risk that a (strong) undesired signal will overload the preamplifier and result in clipping of the signal output from the preamplifier. When the signal is clipped severe non-linear distortion is introduced.

FIG. 2d depicts a clipped signal. This signal illustrates the output of a preamplifier during an overload situation where peak clipping takes place. The signal is clipped symmetrically at approximately +/−900 mV which amplitude may be set by a level of the power supply voltages available to the preamplifier.

When clipping occurs, information in the analogue transducer signal is lost in the time intervals where clipping occurs. Since clipping may occur during a substantial time interval, say 100 ms, loss of a substantial amount of information and severe distortion may be the result. Especially when the transducer is a microphone and the desired signal is a speech signal the result may be that periods of speech are cut out and hence that it will be impossible to understand the speech when the signal from the transducer is reproduced by a signal chain comprising the transducer, the clipping preamplifier and a loudspeaker.

FIG. 2e depicts a desired signal superposed on a subdued undesired signal. This signal may be present at node ‘b’ of the circuit shown in FIG. 1. The result thereof is a signal where the peak magnitude is reduced to below about 200 mV which is below the level of clipping. Thus when this signal is output from a preamplifier with a maximum output signal swing above 200 mV clipping does not occur. It can be seen that the signal to some extent correspond to the desired signal described above in connection with FIG. 2a. However, the signal is different from the desired signal described above since a subdued portion of the undesired signal remains. This signal can be output from the signal conditioner when configured properly.

FIG. 3a depicts a frequency spectrum of a desired and a low-frequency interfering signal. The frequency spectrum illustrates a situation like the one illustrated above in the time domain—that is, a strong low-frequency signal dominates the output of the transducer. The desired signal is depicted as a band-limited signal 302 and the interfering signal is depicted as a band-limited signal 301.

FIG. 3b depicts the frequency-amplitude spectrum of a desired signal and an in-band undesired signal. The frequency spectrum illustrates a situation where the interfering signal 301 lies in the frequency band of the desired signal 302.

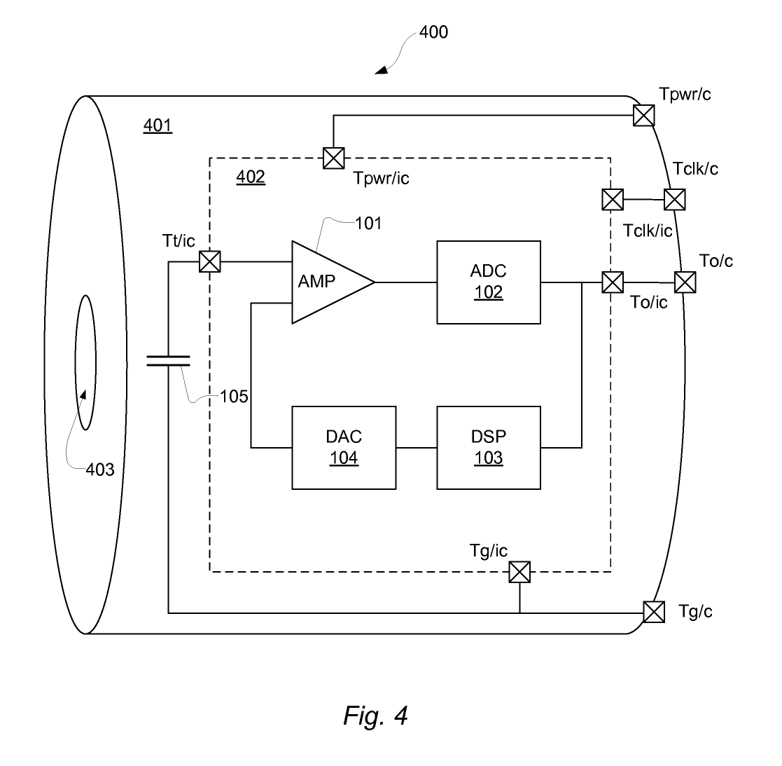

FIG. 4 shows a capsule or housing 401 with a microphone transducer 105 and an integrated circuit 402 arranged therein. Such a unit is also denoted a microphone 400. The capsule 401 has a sound inlet port 403 to allow for sound propagation towards a deflectable diaphragm or membrane portion of the microphone transducer 105. The diaphragm moves relative to a fixed backplate member of the microphone transducer 105. Thereby the microphone transducer constitutes a capacitive transducer. The capsule 401 is small in size and typically shaped as a cylinder with a diameter and a length of about 1 to 4 mm. Within the capsule 401 a semiconductor die with an integrated circuit is mounted. Thus the capsule accommodates the semiconductor die and the microphone transducer.

The integrated circuit 401 is electrically coupled to the microphone transducer 105, the capsule 402 and an external circuit (not shown) via pads on the semiconductor die. These pads are designated by a “tic”. The pads serve as an interface to the integrated circuit on the semiconductor die. Terminals on the capsule 401 are provided for establishing connections between the integrated circuit and the external world such as corresponding terminals of a mobile terminal. These connections are denoted “/c”.

The integrated circuit 402 is configured as a signal conditioner with a preamplifier 101, an analogue-to-digital converter 102, a digital signal processor 103 and a digital-to-analogue converter 104.

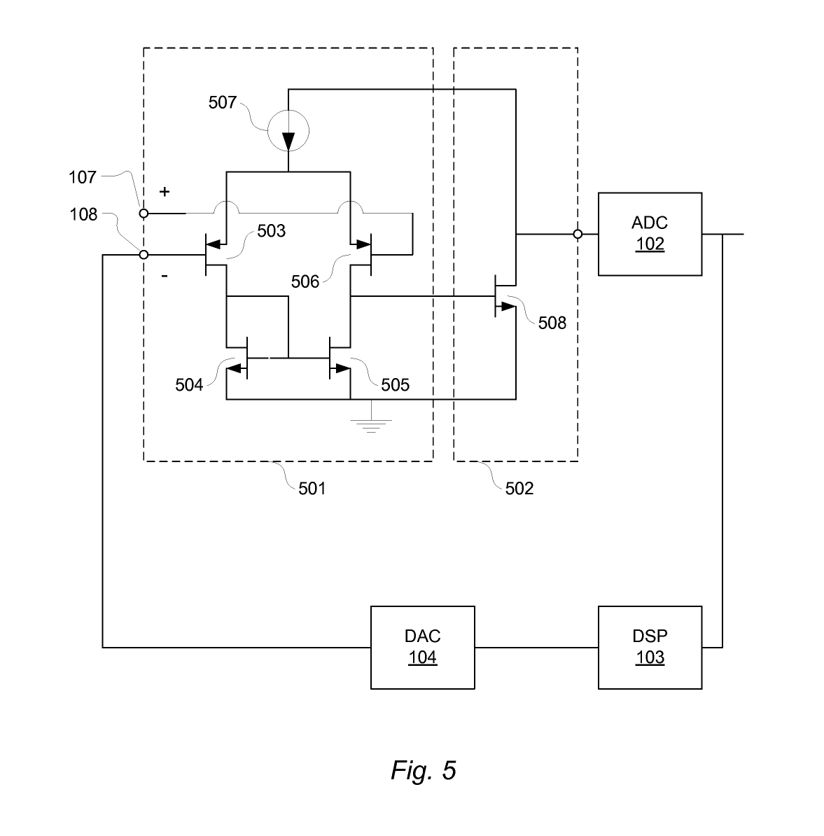

FIG. 5 shows a signal conditioner with a gain stage or preamplifier shown in detail. The preamplifier comprises an input stage 501 and an output stage 502. The input stage 501 comprises a differential pair of p-channel transistors 503, 506. The transistors 503 and 506 are respectively assigned to the inverting input and non-inverting input of the preamplifier and is placed in a first branch and a second branch of the input stage. A current source 507 delivers a constant current to the first and second branch. A current-mirror configuration comprising n-channel transistors 504 and 505 ensures that the current flowing in the first branch is mirrored to flow in the second branch. As known, the control inputs of the transistors 504 and 505 in the current-mirror are interconnected and coupled to the first branch.

At the output stage 502 of the preamplifier, a transistor 508 is connected to the second branch of the input stage at the node between the transistor 506 and 505. This node is generally considered to have high output impedance and hence the transistor 508 is provided to establish lower output impedance at the output of the preamplifier. Additionally the transistor 508 provided increased gain of the preamplifier. Thus, an exemplary preamplifier or gain stage with a differential input stage and an output stage is described.

The differential pair of transistors will have to be optimized in both width and length as an optimum for 1/f noise and white noise exists. If needed, an offset can be built into the differential pair by adjusting the aspect ratio of the two transistors in the differential pair. Alternatively or additionally, the mirroring factor of the current mirror 504, 505 can be adjusted. If the ratio between the aspect ratio of the differential pair transistors are A and the current mirror factor is B, the offset of the amplifier will be n*Vt*In(A*B).

The transistors are for instance MOSFET devices. It should be noted that various implementations of a differential input stage exist—for instance, the n-channel current mirror 604, 605 can be replaced by a so-called folded cascode in combination with a p-channel current mirror.

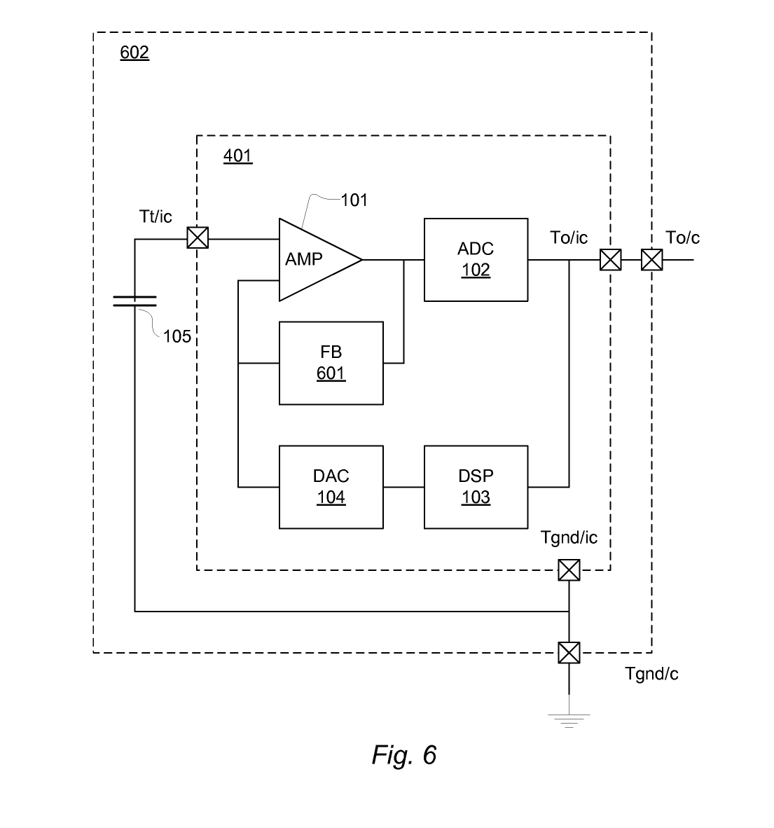

FIG. 6 shows a signal conditioner 401 with an analogue feedback filter 601. In this configuration of the signal conditioner 401 a feedback path FB, 601 is provided in a branch from the output of the preamplifier 101 and back to the input of the preamplifier so as to provide the preamplifier 101 with a feedback loop. This feedback loop operates as a further feedback loop relative to the feedback loop established by the preamplifier 101, the analogue-to-digital converter 102, the digital signal processor 103 and the digital-to-analogue converter 104. These two feedback loops can be considered an inner and an outer feedback loop, respectively.

In order to ensure that the input node at which the signal from the capacitive transducer 105 is received is not disturbed in terms of impedance and thus noise, the signal from the transducer and the feedback signal are coupled separately to respective ones of the inverting input and the non-inverting input of the preamplifier.

In an embodiment the feedback path 601 implements a low-pass filter. Thereby the transfer function of the preamplifier will appear as a high-pass filter.

In an embodiment the feedback path 601 comprises a capacitor to make the gain stage 101 and the feedback path 601 operate as an integrator. In the frequency domain an integrator has a gain-transfer function with a pole located at a very low frequency (close to DC for example at 1 Hz or 10 Hz) at which the gain it at its maximum and for higher frequencies a negative slope. When the integrator operates as a portion of the loop where the digital signal processor 103 is a portion of the feedback path, it is possible to achieve an improved signal-to-noise ratio towards lower frequencies.

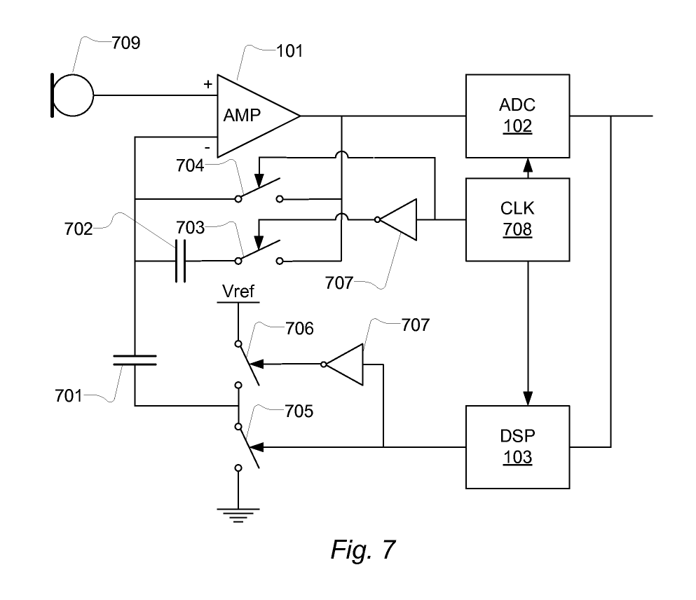

FIG. 7 shows a signal conditioner with a switched capacitor digital-to-analogue converter. The signal conditioner is described above, but in this configuration the digital-to-analogue converter is shown in greater detail. The transducer is shown to be a microphone 709.

A clock generator 708 supplies a clock signal to a switched-capacitor implementation of a digital-to-analogue converter and to the analogue-to-digital converter 102 and the digital signal processor 103. The digital signal processor 103 supplies a 1-bit signal, which controls switching of a capacitor 701. The switching is performed by a first switch 705 and a second switch 706 which are both interconnected with the capacitor 701 at a first circuit node. The first switch 705 is controlled by a signal with the same phase (φ₁) as the 1-bit signal whereas the second switch is controlled via an inverter 707 so as to be operated in an opposite phase (φ₂) of the 1-bit signal. Since the first switch 705 and the second switch 706 are connected to a ground reference and a supply voltage reference (Vref) respectively, the first circuit node can be set to the ground reference or the supply voltage reference.

The capacitor 701 is also connected (at its other terminal) to the inverting input of the amplifier 101 and to a feed-back circuit comprising capacitor 702 and switches 703 and 704. The clock generator supplies a clock signal which controls the switch 704 at the phase (φ₁) and via inverter 707 also switch 703, but in opposite phase (φ₂). Switch 704 is coupled in parallel with a series connection of capacitor 702 and switch 703 so as to form a two-port feedback circuit coupled between the output and the inverting input of the amplifier 101. Thereby a digital-to-analogue converter is provided in switch-capacitor technology.

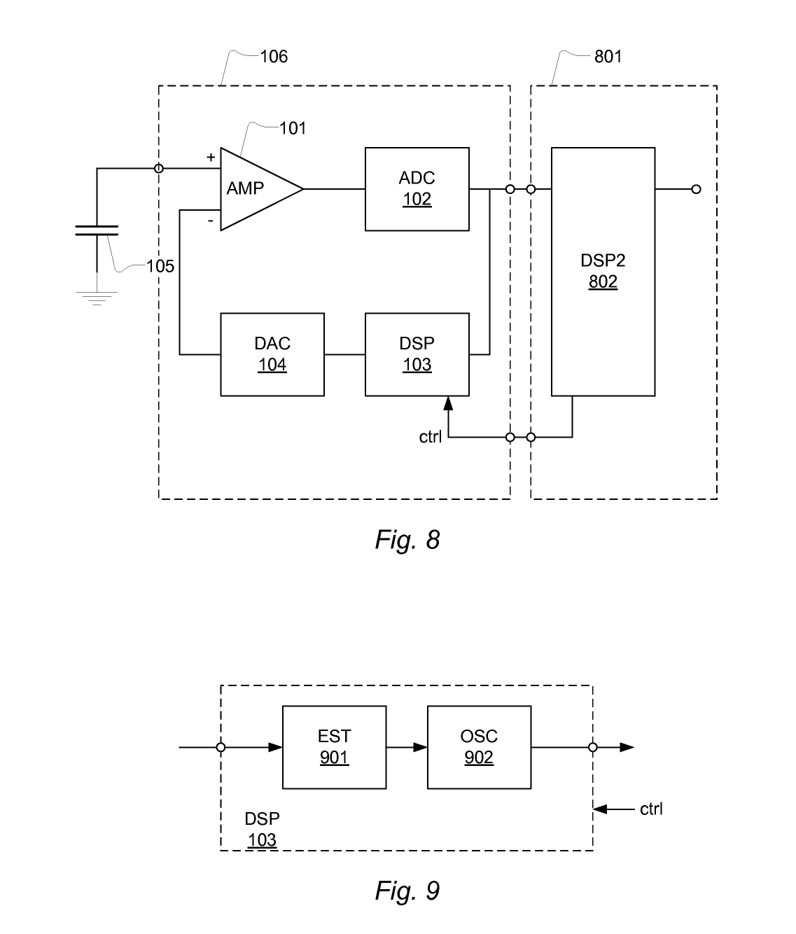

FIG. 8 shows a transducer, a signal conditioner 106 and an external circuit 801. The external circuit 801 is a circuit that is configured to receive a signal from the capacitive transducer 105 via the signal conditioner 106. The external circuit 801 may be e.g. a portion of a mobile terminal or telephone, a camera, a computer or another device. The external circuit 801 may provide a signal with operating power to the signal conditioner 106, a clock signal, a control signal or other types of signals for operating the signal conditioner and/or transducer. A control signal ctrl is shown.

A sub-circuit of the external circuit 801 is denoted DSP2, 802. This sub-circuit has digital signal processing capabilities and is typically denoted a digital signal processor. DSP2 is different from the DSP integrated with the signal conditioner 106 since its so-called DSP-core than the DSP-core of the DSP integrated with the signal conditioner 106. That is, DSP2 occupies more die area and/or is embodied with a process of manufacture that results in a more compact circuit. Thus, DSP2 is typically able to provide more complex signal processing capabilities since it does not have to meet the same die area constraints as the DSP integrated with the signal conditioner.

In an embodiment, DSP2 is configured to receive a signal from the transducer 105 via the signal conditioner 106, which provides the signal from the transducer in digital and processed form. Additionally, DSP 103 is controlled from DSP2 of the external circuit 801 via a first control signal so as to adapt its signal processing capabilities accordingly. Further, DSP2 is configured to detect features of a signal from the signal conditioner and to communicate back to DSP, 103 how to process a signal.

This has the advantage that DSP2, which may have a larger signal processing capability than DSP, 103 can be configured to determine more accurately how to process a contaminated analogue transducer signal to obtain the target signal. Since DSP2 is configured to communicate back to DSP, 103 (e.g. via the control signal or bus, ctrl) how to process a signal, it is possible to save signal components of the signal from the transducer. Whereas, alternatively, either the signal components would be lost or DSP2 should be configured to estimate such lost signal components. Communication and control in this respect are disclosed in greater detail in the co-pending application WO2007/009465.

For instance DSP2 is configured to detect features of a signal which are present when the transducer is a microphone and it is exposed to so-called wind-noise i.e. acoustical noise generated by turbulent fluctuations in air-pressure around the microphone inlet. When such features are detected by DSP2 it communicates back to DSP, 103 e.g. to shift a high-frequency cut-off point of the signal conditioner to a higher frequency and vice versa when predetermined signal features are absent. Such a signal processing strategy can reduce the risk of clipping the signal from the capacitive transducer 105.

Further, since typically DSP2 is more closely integrated with the external circuit, i.e. they have a larger bandwidth of communication; it is possible to enable control of DSP2 from a user interface of the device, which the external circuit is a portion of. Confer the above example, a user interface can provide control of signal processing strategy in so-called wind-noise situations. For example it is possible to enable or disable the signal processing strategy shifting the high-frequency cut-off point of the signal conditioner to a higher frequency and vice versa and/or to set to which extend the high-frequency cut-off point should be moved.

The digital signal processor 103 may be configured to implement a digital filter which may have a fixed filter configuration, a programmable configuration or an adaptive configuration. The filter may be a FIR (Finite Impulse Response) filter or an IIR (Inifinite Impulse Response). The latter also being known as a recursive filter. Generally, recursive filters occupies less die area than a FIR filter. The filter may be e.g. a low-pass filter, implementing a transfer function H(z) like:

$$H ( Z ) = \frac{{b}_{0} + {b}_{1} {Z}^{- 1}}{{a}_{0} + {a}_{1} {Z}^{- 1}}$$

where a and b are coefficients of the filter. In an embodiment b=1−a. One or more of the coefficients may have the value zero.

Alternatively, the filter may be a so-called digital bi-quad filter, implementing a transfer function H(z):

$$H ( z ) = \frac{{b}_{0} + {b}_{1} {Z}^{- 1} + {b}_{2} {Z}^{- 2}}{{a}_{0} + {a}_{1} {Z}^{- 1} + {a}_{2} {Z}^{- 2}}$$

The bi-quad filter can be implemented according to a direct form type one, using four shift-registers, or a direct form type two, using two shift-registers. Two, three or more filters may be coupled in series to provide a higher-order filter. The bi-quad filter is efficient in terms of die area since it is of the IIR type. When implemented in sections of bi-quad filters connected in series, a higher order filter can be implemented without causing the stability problems that are known to easily occur when recursive filters are implemented with discrete-valued coefficients in a digital signal processor. One or more of the coefficients may have the value zero.

In an embodiment, the value of the coefficients of the filter can be changed to change the characteristics of the filter. The change of values can be implemented in different ways e.g. by selecting a preconfigured value among different, preconfigured values of coefficients individually or by selecting a set among different sets of preconfigured values. The selection can be performed via the control signal ctrl.

In an embodiment, the filter can comprise one or more notch filters to notch out selected narrow frequency bands. DSP2 may be configured to estimate the frequency of undesired frequency components and provide to DSP1 filter coefficients that implement notch filter(s) that attenuate or suppress the signal components at the estimated frequencies. The estimation may be carried out by a method comprising auto-correlation estimation and/or frequency spectrum estimation as is well-known in the art of signal processing.

In an embodiment, DSP2 is configured to provide filter coefficients to DSP1 calculated from an estimate of the frequency of undesired frequency components and an estimate of the amplitude of the undesired frequency component and/or an estimate of the bandwidth of the undesired frequency component. Thus, a frequency component is to be considered as a relatively narrow band of frequencies. Typically, the narrow band of frequencies is within minus 3 dB limits of less than one decade.

The notch filter(s) may be implemented in series with a low-pass filter to diminish both low-frequency components and selected, narrow frequency bands. Say an audio-band is defined, then the low-pass filter can remove signal components below the audio-band and one or more notch filters can remove components in the audio-band, but in narrow bands about selected frequencies. Notch filters can be implemented by means of one or more biquad filters.

In an embodiment, DSP2 and DSP1 are configured in such a way that DSP2 can set the gain of the signal conditioner by controlling the gain of DSP1.

FIG. 9 shows an embodiment of the digital signal processor. The digital signal processor 103 comprises an estimator 901 and a controllable oscillator 902. The estimator 901 receives a digital signal from the analogue-to-digital converter 102. The digital signal may comprise a desired signal e.g. speech and an undesired signal in the form of tones.

To attenuate the effect of such an undesired signal, the estimator is configured to estimate parameters of a dominating signal component such as tones e.g. parameters like frequency, phase and amplitude. These estimated parameters are used to control the oscillator 902 which generates synthesized tones from the parameters. Output from the oscillator is the output from the DSP 103 and is supplied to the digital-to-analogue converter 104. Thereby the undesired signal is estimated and synthesized to provide the synthesized version as a negative feedback signal to the amplifier 101.

The estimator is configured to estimate tones, except from tones which are those typically generated by quasi-stationary components of human speech. Thus, it could happen that tones of a whistle or hum sound produced by a human could be taken as undesired signals. Consequently, such signals or portions of them would be operatively blocked by the signal conditioner. At least for that reason, in an embodiment, the provision of synthesized feedback signals can be enabled or disabled from or via an external circuit. A signal “e/d” for enabling or disabling provision of synthesized feedback signals is input to the DSP.

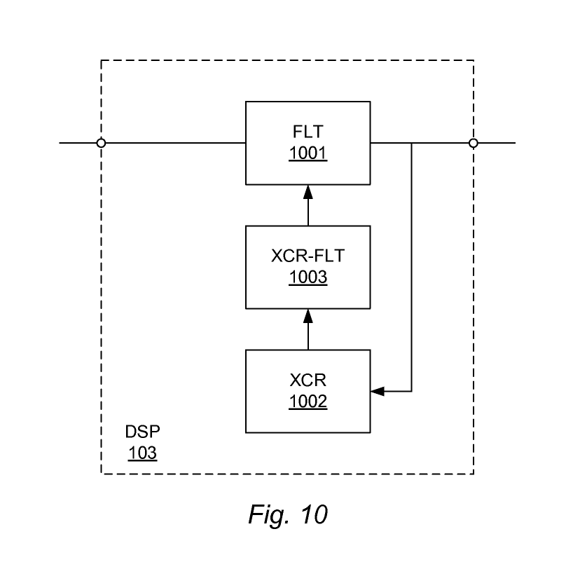

FIG. 10 shows in schematic form an embodiment of the digital signal processor. The digital signal processor is configured with an adaptive filter. In the embodiment, the digital signal processor 103 comprises a unit XCR, 1002 for estimating an auto-correlation of the signal input to the signal processor, a unit XCR-FLT, 1003 to determine values of filter coefficients from an estimate of the auto-correlation of the signal input to the signal processor, and a filter FLT, 1001 to filter the signal input to the signal processor and to provide an output signal depending on the values of its filter coefficients.

Various strategies for adapting the filter can be applied, but one may be to adapt the filter to suppress signals with strong autocorrelation. In that case, the digital signal processor 103 is configured with an adaptive filter to suppress a component of the input signal that has a relatively weak autocorrelation relative to a component that has a relatively strong autocorrelation. Thereby, signals with a relatively weak autocorrelation will be diminished in the output from the digital signal processor relative to signals with a relatively strong autocorrelation. The latter-mentioned will thus constitute stronger negative feedback and be diminished in the output from the signal conditioner 106.

The unit configured to estimate the autocorrelation is configured to estimate an autocorrelation, where tones, in addition to tones which are those typically produced by human speech, are identified.

1. A semiconductor die with an integrated circuit providing a signal conditioner for a capacitive transducer, comprising:
a gain stage configured to receive an analogue transducer signal on a first input and a feedback signal on a second input;
an analogue-to-digital converter coupled to receive an output signal of the gain stage and to provide a digital signal,
the feedback signal is provided via a digital-to-analogue converter and a digital signal processor receiving the digital signal characterized in that:
a latency or time delay through a feedback loop or path, formed from an input of the analogue-to-digital converter to the feedback signal at the second input of the gain stage, is smaller than 50 μS.

2. A semiconductor die according to claim 1, wherein a resolution of the digital-to-analogue converter is higher than a resolution of the analogue-to-digital converter.

3. A semiconductor die according to claim 2, wherein the resolution of the digital-to-analogue converter in an audio bandwidth between 20 Hz and 20 kHz is more than 6 dB, or more than 10 dB, or more than 20 dB higher than the resolution of the analogue-to-digital converter.

4. A semiconductor die according to claim 1, wherein the digital-to-analogue converter is operated at a higher clock frequency than the analogue-to-digital converter.

5. A semiconductor die according to claim 1, wherein at least one of the analogue-to-digital converter and the digital-to-analogue converter is operated at an over-sampled sampling rate.

6. A semiconductor die according to claim 5, wherein the over-sampled sampling rate is higher than 48 kHz.

7. A semiconductor die according to claim 1, wherein the gain stage is configured as an integrator.

8. A semiconductor die according to claim 1, wherein an open loop small signal gain of the gain stage is larger than 40 dB at 20 Hz.

9. A semiconductor die according to claim 1, wherein the gain stage comprises a differential input stage having respective input terminals separately connected to the feedback signal and the analogue transducer signal.

10. A semiconductor die according to claim 1, wherein the digital signal processor comprises a digital high-pass filter.

11. A semiconductor die according to claim 1, wherein the digital signal processor is configured with a digital low-pass filter and the digital low-pass filter is controlled in response to the input signal.

12. A semiconductor die according to claim 1, wherein the digital signal processor comprises a signal estimator configured to:
estimate an amplitude and/or phase of a dominating signal component of the transducer signal,
a signal generator controlled by the signal estimator to generate the feedback signal with an amplitude and/or phase determined on basis of the amplitude and/or phase of the dominating signal component.

13. A semiconductor die according to claim 12, wherein the signal estimator is configured to detect a time duration of the dominating signal component.

14. A. semiconductor die according to claim 13, wherein the signal estimator is configured to detect a time duration of the dominating signal component by performing an analysis over periods of time longer than an expected duration of voiced cues of human speech.

15. A semiconductor die according to claim 12, wherein the signal estimator is configured to detect the time duration of the dominating signal component by auto-correlation or spectral analysis.

16. A semiconductor die according to claim 14, wherein the signal estimator is adapted to control the amplitude and/or phase of the feedback signal based on detected time durations of the dominating signal component.

17. A semiconductor die according claim 1, wherein the digital signal processor is configured with an adaptive filter to suppress a component of the input signal that has autocorrelation values about equidistant delays, where the autocorrelation values significantly represent a persisting oscillation in the signal input to the signal processor.

18. A semiconductor die according to claim 1, wherein at least one of the analogue-to-digital converter and the digital-to analogue converter comprises a single level or multi-level sigma-delta converter.

19. A semiconductor die according to claim 1, wherein the first input of the gain stage has an input impedance larger than 1 GΩ, such as larger than 10 GΩ, or preferably larger than 100 GΩ.

20. An electroacoustical transducer comprising a semiconductor die according to claim 1 arranged inside a transducer housing; and
a transducer element disposed inside the transducer housing and operatively connected to the first input of gain stage to supply the analogue transducer signal.

21. An electroacoustical transducer according to claim 20, where the transducer element comprises a capacitive transducer element.

22. (canceled)
